(19) United States
(12) Patent Application Publication
(10) Pub. No.: US 2008/0279400 A1
(43) Pub. Date: Nov. 13, 2008

(54) System and method for capturing voice interactions in walk-in environments

(76) Inventors: Reuven Knoll, Modiin (IL); Adrian Loffer, Kfar Saba (IL); Gal Yechil, Givaat Shemuel (IL)

Correspondence Address: Pearl Cohen Zedek Latzer, LLP, 1500 Broadway, 12th Floor, New York, NY, 10036, US

(21) Appl. No.: 11/798,072

(22) Filed: May 10, 2007

(51) Int. Cl. H04R 3/00

(52) U.S. Cl. 381/122

(57) ABSTRACT

Device, system and method for capturing and storing face to face voice interaction in a walk-in environment are provided. For example, an end-point in a walk-in environment may include an agent unit to detect an audio signal created by a first participant of a face-to-face interaction and to transmit the audio signal over a wireless communication link, a microphone array to detect an audio signal created by a second participant of the interaction and a capturing unit to receive and process the audio signal from the agent unit and the audio signal from the microphone array and to transmit processed audio signals to a central capture device.

### BACKGROUND

The need for a simple and efficient way for capturing client-agent sessions or interactions is well known. Current systems are focused on recording of telephonic and computer-based interactions with customers such as telephone calls, e-mails, chat sessions, collaborative browsing and the like, but are not suitable to record face-to-face voice interactions in walk-in environments where a client has a frontal, face-to-face, interaction with a representative or an agent of a service provider.

The walk-in environments may be service centers, branches of banks, governmental offices, fast food counters, department stores and other private, commercial or government sites. In such an environment, it is very difficult to record a specific interaction between a client and an agent at an acceptable audio quality for several reasons. Firstly, the environmental noise, which is mainly human speech, may not be easily eliminated from the recording. Further, the agent may be required to leave its regular location facing the client during the interaction. Accordingly, existing solutions of voice recording systems are not suitable for noisy crowded environments such as walk-in service centers.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a high-level block diagram of an exemplary walk-in environment according to embodiments of the present invention;

FIG. 2 is a block diagram of an exemplary end-point of a walk-in environment according to embodiments of the present invention;

FIG. 3 is a high-level block diagram of an exemplary input agent unit according to embodiments of the present invention; and

FIG. 4 is a flowchart of a method for capturing agent-client voice interactions at walk-in environments according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF DEMONSTRATIVE EMBODIMETS OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

Although embodiments of the invention are not limited in this regard, the terms “walk-in center” and “walk-in environment” as used herein may be used throughout the specification to describe any place in which a verbal interaction between two or more persons may occurred, for example, service centers of service providers, branches of banks, stores and other private, commercial or government points of presence.

Although embodiments of the invention are not limited in this regard, the term “an agent” as used herein may be used throughout the specification to describe any professional representative of a business or government providing a service to a customer, client or a civilian. Non-limiting examples may include a service provider representative, a clerk in a store, a banker, a tax authority representative and the like.

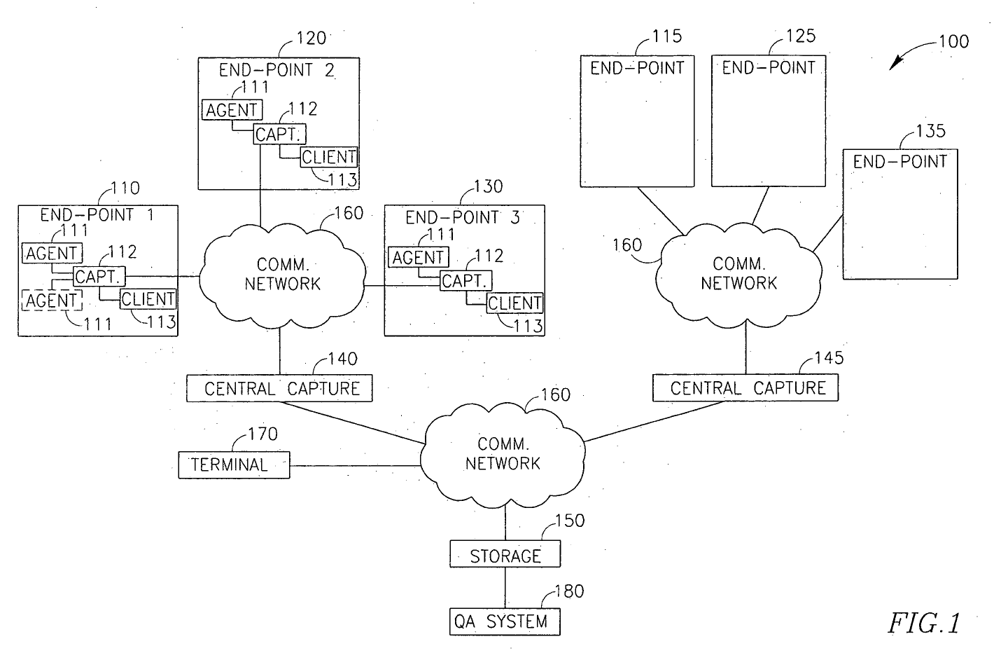

Reference is now made to FIG. 1, which is a high-level block diagram of an exemplary walk-in environment according to embodiments of the present invention. Walk-in environment 100 may include one or more end-points, for example, end-points 110, 120 and 130, all capable of communicating with a central capture device 140 via a wired or wireless communication network 160. Optionally, walk-in environment may include end-points 115, 125 and 135, all capable of communicating with a central capture device 145 via network 160. Although in the exemplary illustration of FIG. 1, six end-points are shown, it should be understood to a person skilled in art that the invention is not limited in this respect and according to embodiments of the present invention walk-in environment 100 may include any suitable numbers of end-points. Throughout the specification and claims an end-point may refer to any kind of frontal, face-to-face point of sale, point of service or any other space in which a verbal interaction between an agent and a client may take place.

Each end-point, for example, end-points 110, 120 and 130 may include one or more agent input devices 111, for example a portable microphone to receive audio signals from agents and an input client unit 113 to receive audio signals from one or more clients. Each end-point 110, 120 and 130 may further include an interaction capture unit 112 to capture voice data from agent input device 111 and from input client unit 113. The audio signals captured by interaction capture unit 112 may be created by at least one agent and at least one client during a face-a-face verbal interaction occurring at the location of the respective end-point 110, 120 or 130. Although in the exemplary illustration of FIG. 1, input client unit 113 and capture unit 112 are stand alone units, it should be understood to a person skilled in art that the invention is not limited in this respect and according to embodiments of the present invention input client unit 113 and capture unit 112 may be embedded in the same housing.

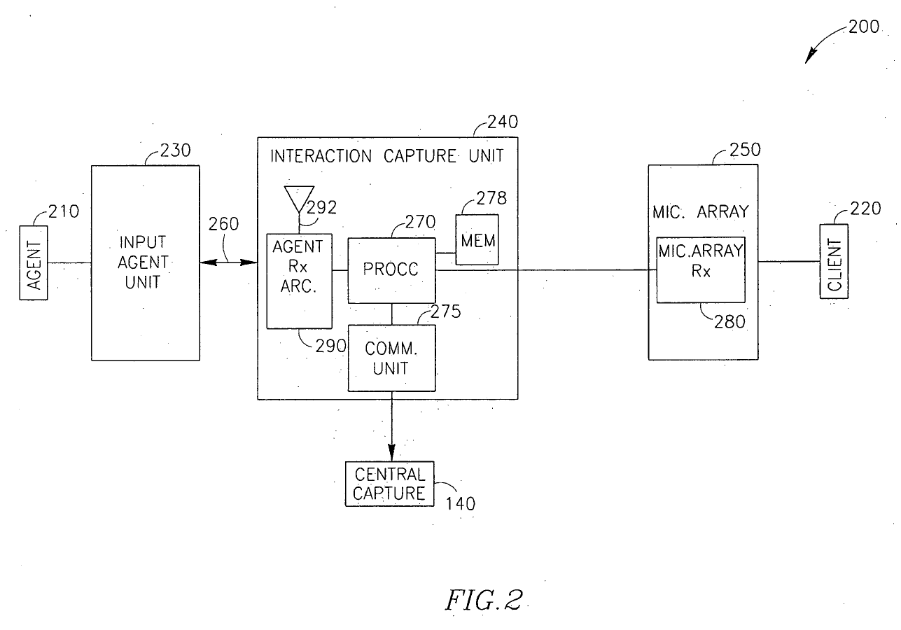

Interaction capture unit 112 may process the captured audio signal, e.g., filter the non-relevant external acoustic sources and may transmit the processed audio signals via a wired or wireless link to central capture device 140, as described in detail below with reference to FIG. 2.

Central capture device 140 may interface one or more end-points, for example, 120 and 130 in environment 100 and may transfer the processed audio signals of a verbal interaction to one or more storage unit 150. In some embodiments of the present invention, central capture device 140 may receive the audio signals from interaction capture units 112 and may process the audio signals before transferring them to storage unit 150. For example, central capture device 140 may combine the audio signals captured by agent input device 111 and the signals captured by input client unit 113 to a synchronized audio signal of an entire face-to-face interaction. In some embodiments, such processing may be performed by interaction capture unit 112 and central capture device 140 may separate the audio signals before transferring them to storage unit 150.

Although the scope of the present invention is not limited in this respect, central capture entity 140 may be implemented using any suitable combination of software and/or hardware and may be implemented as a stand alone unit or as a part of storage unit 150. Central capture device 140 may be coupled to communication network 160 to deliver the processed audio signals, for storage at storage unit 150 or live-monitoring at terminal 170. Storage unit and/or terminal 170 may be coupled to or may be a part of quality assurance or quality management system 180 which may be used for validating that the walk-in environment activities are being performed effectively and efficiently.

According to some embodiments of the present invention, input client unit 113 may include a directional microphone or one or more closely positioned microphones to act like a highly directional microphone in order to detect the audio signals, e.g., voice created by client, as is further described in FIG. 2.

Although the scope of the present invention is not limited in this respect, input client unit 113 may be implemented using a microphone array, which may include a plurality of microphones which may optimize the signal-to-noise ratio (SNR) of the detected audio signal created by client 220 (of FIG. 2). Input client unit 113 may achieve high directionality by taking advantage of the fact that an incoming acoustic wave arrives at each of the microphones at a slightly different time or phase.

Throughout the specification, for simplicity of the illustration, input client unit 113 is referred to a microphone array. It should be understood to a person skilled in art that the invention is not limited in this respect and according to embodiments of the present invention other devices having directional microphone functionalities are likewise applicable.

Communication network 160 may be a Local Area Network (LAN), a Wireless LAN (WLAN), a Metropolitan Area Network (MAN), a Wireless MAN (WMAN), a Wide Area Network (WAN), a Wireless WAN (WWAN) and networks operating in accordance with existing IEEE 802.11, 802.11a, 802.11b, 802.11e, 802.11g, 802.11h, 802.11i, 802.11n, 802.16, 802.16d, 802.16e standards and/or future versions and/or derivatives and/or Long Term Evolution (LTE) of the above standards. By way of example, communication network 160 may facilitate an exchange of information packets in accordance with the Ethernet local area networks (LANs). Such Ethernet LANs conform to the IEEE 802.3, 802.3u and 802.3x network standards, published by the Institute of Electrical and Electronics Engineers (IEEE). In some embodiments, proprietary interface protocols may be used and/or implemented.

Storage unit 150 may be used for voice interaction capturing, storing and retrieval. An exemplary system is sold under the trade name of NiceLog™ by NICE Systems Ltd., R'annana, Israel, the assignee of this patent application. In some embodiments of the present invention, storage unit 150 may further comprise screen capture and storage components for screen shot and screen events interaction capturing and/or video capture and storage component for capturing, storing and retrieval of the visual streaming video interaction coming from one, or more, video camera which may be located at one or more end point 110, 120 and/or 130. Storage unit 150 may include or may be coupled to a database component in which information regarding the interaction is stored for later query and analysis (not shown).

Although the scope of the present invention is not limited in this respect, capture elements, such as interaction capture unit 140 and storage elements, such as storage unit 150 may be separated and interconnected over a LAN/WAN or any other IP based local or wide network, e.g., communication network 160. The storage component 150, which may include a database component (not shown), may either be located at the same location or be centralized at another location covering multiple walk-in environments or branches. The transfer of content such as, voice, screen or other media from the interaction capture units 112 to the central capture unit 140 may either be based on proprietary protocols such as a unique packaging of RTP packets for the voice or based on standard protocols such as H.323 for VoIP and the like.

Reference is now made to FIG. 2, which is a block diagram of an exemplary end-point of a walk-in environment according to embodiments of the present invention. A single session or an interaction at end-point 200 may include at least two participants: an agent 210 and a client 220. End point 200 may include an input agent unit 230 to detect and capture the audio signals created by agent 210, a microphone array 250 to detect the audio signals created by client 220 and an interaction capture unit 240 to receive, capture and process the audio signals transmitted by microphone array 250 and input agent unit 230. As discussed above, although in the exemplary illustration of FIG. 2, a microphone array is described, it should be understood to a person skilled in art that the invention is not limited in this respect and according to embodiments of the present invention other devices having directional microphone functionalities are likewise applicable.

According to some embodiments of the present invention, input agent unit 230 may be a portable unit having dimensions small enough to be easily attached to and detached from the agent's clothing or body. In other embodiments agent unit 230 may be a fixed device, e.g., fixed to a desk, a computer or other equipment at the location of end-point 200. According to some embodiments of the present invention, agent unit 230 may detect and capture the voice stream created by agent 210 and may filter all external acoustic sources other than agent 210 voice. Agent unit 230 may further transmit the captured voice stream to local interaction capture unit 240 via a communication connection 260.

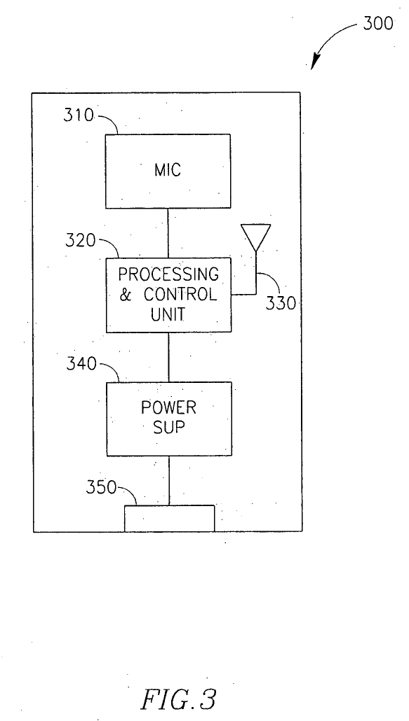

For a wireless agent unit, the transmission may be done via a wireless connection, for example a radio frequency (RF) connection. For a fixed agent unit, the transmission may be done via any wired connection, as known in the art. In some embodiments of the present invention, filtering and further processing of the voice stream detected by agent unit 230 may be performed by interaction capture unit 240. Input agent unit 230 may be implemented using hardware components or any suitable combination of software and hardware, as is described in detail below with reference to FIG. 3.

Communication connection 260 may be a power-efficient and inexpensive interface, implemented for example, by proprietary unidirectional Wireless Personal Area Network (WPAN) protocols for low power networks, standard Radio Frequency (RF) protocols or proprietary RF protocols. Other communication protocols and methods may be used, e.g., zigbee I, zigbee II, bluetooth or IEEE 802.15.4.

According to the characteristics of a certain walk-in environment, e.g., walk-in environment 100 of FIG. 1, client 220 may be a different person in each interaction and may have various positions within the limited space of end-point 200. Detecting and/or capturing the voice created by client 220 by microphone array 250 may require competing with the various positions and different speakers and may further require competing with a plurality of possible acoustic noise sources and non acoustic noise sources. Acoustic noise sources may include for example, direct sound sources, such as other humans, machinery and the like, ambient sound sources, such as reflected sound waves from all direct sound sources. Additional degradation in speech quality may rise from frequency domain limitations as is known in the art. Non acoustic noise sources may result, for example, from electronics noise figure (NF) and non-linear distortions of the amplification stages.

The design of microphone array 250 may be based on microphone phase array technology and may include one or more microphones which may optimize the signal to noise ratio (SNR) of the detected audio signal created by client 220. Microphone array 250 may include a set of closely positioned microphones to achieve better directionality than a single microphone by taking advantage of the fact that an incoming acoustic wave arrives at each of the microphones at a slightly different time or phase.

Non-Limiting examples of microphone array design may include a two-element microphone array, a straight four-element microphone array and L-shaped 4-element microphone array. Microphone array 250 may combine the signals detected by all microphones, and may act like a highly directional microphone, forming what is also referred to herein as “a beam” which is a known in the art term. This microphone array beam may be electronically managed to point to the speaker, e.g, client 220. Using microphone array 250 may be mechanically equivalent to using two highly directional microphones: one for scanning the end-point space and for measuring the sound level, and the other for pointing to the direction with the highest sound level, e.g., toward client 220.

According to some embodiments of the present invention, microphone array 250 may detect and/or capture audio signals from client 220 and may transmit these audio signals to local interaction capture unit 240. According to some embodiments of the present invention, microphone array 250 may include a microphone array receiving unit 280 to amplify and sample the audio signal detected by microphone array 250.

According to some embodiments of the present invention, interaction capture unit 240 may include an agent receiving unit 290 to receive the voice transferred from input agent unit 230, a processor 270 coupled to units 280 and 290 to process the received signals and a communication interface unit 275. Processor 270 may further control input agent unit 230 and optionally microphone array 250. According to embodiments of the present invention, processor 270 may sum the voice streams received from input agent unit 230 and microphone array 250 and may deliver a data stream of a complete verbal interaction between agent 210 and client 220.

Optionally, according to some embodiments of the invention, processor 270 may include or may be coupled to a memory unit 278. Memory unit 278 may be used as a buffer to store temporary data, for example, when the communication between capture unit 240 and the central capture 140 may be down. Although the scope of the present invention is not limited in this respect, types of memory that may be used with embodiments of the present invention may include, for example, a shift register, a Flash memory, a random access memory (RAM), dynamic RAM (DRAM), static RAM (SRAM) and the like.

According to embodiments of the present invention, unit 280 may include one or more amplifiers and one or more analog-to-digital (A/D) converters (not shown) to prepare the detected voice for further processing, such as but not limited to, filtering by processor 270. In some embodiments, unit 280 may include an amplifier and an A/D converter for each microphone of microphone array 250. Unit 280 may further contain a control circuitry to transmit control signals from processor 270 to microphone array 250. Microphone array receiving unit 280 may contain other blocks or circuitry. Microphone array receiving unit 280 may be implemented using hardware components or any suitable combination of software and hardware.

Microphone array 250 may be positioned in front of client 220 to produce high directivity “beam”, which may be considered as an acoustical phased array antenna with narrow controlled main beam and minimal side lobes by changing the weight of the signal received from each microphone of microphone array 250 by processor 270. Processor 270 may create the “beams” by, for example, weighted summation of all microphone array signals or other algorithms and may control the “movement” of the beam in order to track client 220 by applying mathematical algorithms on the signals received from microphone array receiving unit 280.

According to embodiments of the present invention, processor 270 may search for the position of client 220 and may aim the beam in that direction by using for example, special software. When client 220 moves, processor 270 may control microphone array 250 to follow the sound source by applying a software tracking algorithm. By way of example, the tracking algorithm used may be the GBD of Microsoft® designed by Ivan Tachev and Henrique S. Malvar.

According to some embodiments of the present invention, processor 270 may be a general-purpose processor. Additionally or alternatively, processor 270 may include a digital signal processor (DSP), a microprocessor, a host processor, a controller, a plurality of processors or controllers, a chip, a microchip, one or more circuits, circuitry, a logic unit (FPGA), an integrated circuit (IC), an application-specific IC (ASIC), or any other suitable multi-purpose or specific processor or controller. In some embodiments of the invention, processor 270 may be implemented as an integrated unit in microphone array 250.

According to some embodiments of the present invention, in which input agent unit 230 is a wireless device and communication connection 260 is implemented as wireless connection, agent receiving unit 290 may include an antenna, for example, a dipole antenna 292 to receive the audio signals transferred from input agent unit 230 via the wireless connection, an amplifier circuitry and an RF demodulator circuitry (not shown) to demodulate the audio signals received from input agent unit 230. The output of the demodulator circuitry or other circuitry may be further processed by processor 270. Processor 270 may transfer the agent voice stream and the client voice stream as separate channels or in an combined stream via communication interface unit 275 to a higher level; for example, central capture unit 140 of FIG. 1. Interaction capture unit 240 may be in operable communication with central unit 140 via a wired or wireless communication link.

Interface communication unit 275 may include circuitry and physical components for transferring the captured and processed voice streams or audio signals via a communication network, e.g., network 160 of FIG. 1 to peripherals units such as, central capture unit 140 and/or a personal computer, e.g., the personal computer of agent 210. According to some embodiments of the present invention, interface unit 275 may include, for example, layer 2-switch circuitry, physical connectors such as RJ45 connectors and the like. Other circuits and/or physical connectors may be used.

Although the scope of the invention is not limited in this respect, the space architecture of endpoint 200 may follow the exemplary specification detailed herein. According to an exemplary embodiment of the invention, the distance between client 220 and microphone array 250 may be no more than 1.5 meter, the angle between client 220 and interaction capture unit 240 may be not more than ±45 degrees in the horizontal plane and the angle between client 220 and endpoint 200 may be not more than −30 to 45 degrees in the vertical plane.

According to an exemplary embodiment of the invention, the agent may carry agent unit 230 such that the distance between the agent unit and the agent's mouth may not exceed 0.3 meters, the distance between agent unit 230 and interaction capture unit 240 may not exceed 20 meters and the distance between microphone array 250 and other direct sound sources at other end-points may be no less then 3 meters. Other distances may be used.

Reference is now made to FIG. 3, which is a high-level block diagram of an exemplary input agent unit according to embodiments of the present invention. According to some embodiments, input agent unit 300 may record the audio signal created by, for example, agent 210 in walk-in environment 100. In some embodiments input agent unit 300 may be portable and may have small dimensions to allow simple attachment to an agent clothing or body to allow high recording quality without limiting the agent's movement. Input agent unit 300 may include one or more microphones 310, for example, wireless omni directional microphone to receive and detect the voice of agent 210 of FIG. 2. Any other microphone or microphones may be used.

Input agent unit 300 may comprise a processing and control unit 320 to capture the analog voice signal received by microphone 310, to process the signal and to transfer the processed signal to interaction capture unit 240. The received and/or processed signal may be transmitted via antenna 330 which may include or may be for example, a PCB printed folded dipole antenna or any other antenna as is known in the art.

According to some embodiments of the present invention processing and control unit 320 may include amplifying circuits and/or other components to amplify the analog audio signal received from and/or detected by microphone 310, an analog-to-digital (A/D) converter to convert the received analog audio signal to a digital signal for further processing and a transmitting circuitry to transmit the processed signal via a wireless connection, e.g., connection 260 of FIG. 2 to interaction capture unit 240.

Although embodiments of the invention are not limited in this regard processing and control unit 320 may include circuitry for filtering the external acoustic sources other than the voice of agent 220 and for controlling the transmission of the processed signal according to the required communication protocol, for example, a proprietary RF protocol which may include a handshake with RF link band of 2400-2480 Mhz. Any other license free link band may be likewise used.

According to some embodiments of the present invention processing and control unit 320 may include a general-purpose processor. Additionally or alternatively, processing and control unit 320 may include a digital signal processor (DSP), a microprocessor, a host processor, a controller, a plurality of processors or controllers, a chip, a microchip, one or more circuits, circuitry, a logic unit, an integrated circuit (IC), an application-specific IC (ASIC), or any other suitable multi-purpose or specific processor or controller.

According to some embodiments of the present invention agent device 300 may include a power supply 340 which may be, for example, a rechargeable battery such as lithium ion battery, super iron battery and the like. Power supply 340 may be recharged via charge pins 350 and may allow an easy maintenance of agent device 300. Although embodiments of the invention are not limited in this regard power supply 340 may have dimensions which are small enough to be included in a personal portable device and may work for several hours, e.g., up to 9 hours without the need to recharge it.

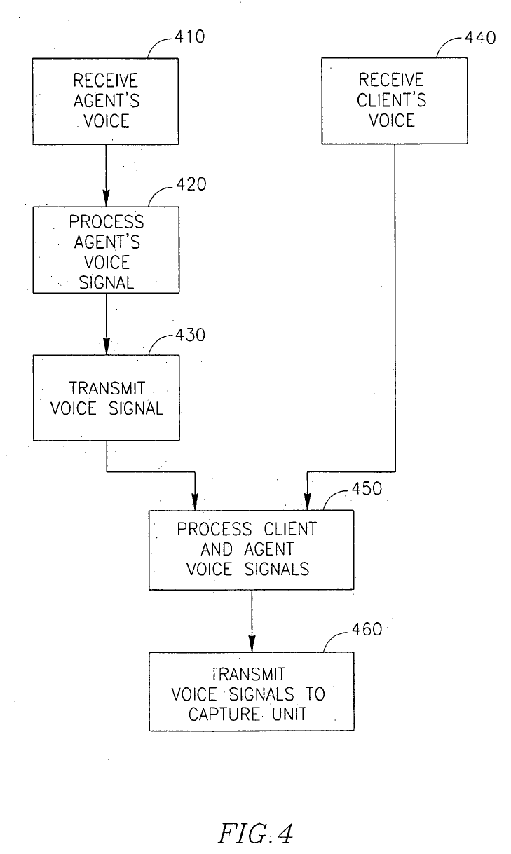

Reference is now made to FIG. 4, which is a flowchart of a method for capturing voice interactions in walk-in environments according to embodiments of the present invention. This procedure, as illustrated, may be performed for each end-point of a walk-in environment. Operations of the method may be implemented, for example, by system 100 of FIG. 1, by any or all of stations or end-points 110, 120 and 130 of FIG. 1, by end-point 200 of FIG. 2, and/or by other suitable units, devices, and/or systems.

As indicated at box 410, the method may include receiving audio stream signals of the voice created by a participant of a face-to-face interaction, for example, agent 210 (of FIG. 2) by one or more microphones. As indicated at box 420, the method may include further processing of the audio signals received at box 410, for example, amplifying the signals, converting the signals from analog signals to digital signals and filtering external noises and reverberations other than agent 210 voice.

As indicated at box 430, the method may include transmitting the signals processed at block 420 via a communication link, for example, RF wireless communication to a capture unit, for example, interaction capture unit 240 (of FIG. 2). As indicated at box 440, the method may include receiving audio stream signals of the voice created by another participant of the face-to-face interaction, for example, client 220 (of FIG. 2) by a microphone array unit.

As indicated at box 450, the method may include processing the audio signals received at boxes 440 and 420, for example, beam forming, filtering external noises and reverberations other than client 220 and agent 210 voices. The method may further include processing of the received signals or controlling of the receiving microphones, e.g., microphone array unit 250 in order to optimize the signal to noise ratio of the received signal, as is described with reference to FIG. 2.

According to some embodiments of the present invention, processing the audio signals received at box 410 may be additionally or alternatively to the processing which is indicated at box 420. According to some embodiments of the present invention the features of the method which are described at boxes 450 and 440 may be implemented at a single physical unit and according to other embodiments may be implemented at separate physical units.

As indicated at box 460, the method may include transmitting the processed signals of the face-to-face interaction to a higher level, for example, central capture unit 140 (of FIG. 1) via a communication network, for example, network 160 (of FIG. 1) for future analysis. Other operations or sets of operations may be used in accordance with embodiments of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An end-point system comprising:
an input unit to detect audio signals created by an agent participating in a face-to-face interaction;
a directional microphone to detect audio signals created by a client participating in the face-to-face interaction; and
a local capture unit to capture and process the audio signals from the input unit and from the directional microphone and to transmit processed audio signals to a central capture unit.

2. The system of claim 1 further comprising:
a second input unit to detect audio signals created by another agent participating in the face-to-face interaction.

3. The system of claim 1, wherein said local capture unit comprises an agent receiving unit to process the audio signals detected by said input unit.

4. The system of claim 1, wherein said input unit is a portable unit able to transmit said audio signals over a wireless communication link.

5. The system of claim 1, wherein said input unit comprises a rechargeable power supply.

6. The system of claim 1, wherein said local capture unit comprises a processor to process the audio signals detected by said directional microphone.

7. The system of claim 1, wherein said directional microphone further able to detect audio signals created by another client participating in the face-to-face interaction.

8. The system of claim 1, wherein said directional microphone being a microphone array.

9. The system of claim 8, wherein said microphone array being a single-element microphone array, two-element microphone array or four-element microphone array.

10. The system of claim 1, wherein said system being a part of a walk-in center environment.

11. A system comprising:
a central capture unit; and
one or more end-points, each of the end-points comprises:
an input unit to detect audio signals created by an agent participating in a face-to-face interaction;
a directional microphone to detect audio signals created by a client participating in the face-to-face interaction; and
a local capture unit to capture and process the audio signals from the input unit and from the directional microphone and to transmit processed audio signals to said central capture unit.

12. The system of claim 11 further comprising:
a storage unit capable of receiving captured audio signals from the central capture unit.

13. The system of claim 11, wherein said local capture unit comprises an agent receiving unit to process the audio signals detected by said input unit.

14. The system of claim 11, wherein said input unit is a portable unit able to transmit said audio signals over a wireless communication link.

15. The system of claim 11, wherein said input unit comprises a rechargeable power supply.

16. The system of claim 11, wherein said local capture unit comprises a processor to process the audio signals detected by said directional microphone.

17. The system of claim 11, wherein said directional microphone being a microphone array.

18. The system of claim 17, wherein said microphone array being a single-element microphone array, two-element microphone array or four-element microphone array.

19. The system of claim 11, wherein said one or more end-points being a part of a walk-in center environment.

20. The system of claim 11, wherein said central capture unit is coupled over a communication network to a terminal for live-monitoring.

21. The system of claim 11, wherein said central capture unit being a part of a quality management system.

22. A method comprising:
detecting audio signals created by an agent participating in a face-to-face interaction using an input unit;
detecting audio signals created by a client participating in the face-to-face interaction using a directional microphone; and
capturing and processing the audio signals created by the agent and by the client and transmitting processed audio signals to a central capture unit.

23. The method of claim 22 comprising:
transmitting the processed audio signals to a storage unit.

24. The method of claim 22 comprising:
transmitting the processed audio signals to a terminal for live monitoring.

25. The method of claim 22 comprising:
transmitting the processed audio signals to a quality management system.

26. The method of claim 22 comprising:
detecting audio signals created by another agent participating in the face-to-face interaction using a second input unit.

27. The method of claim 22 comprising:
detecting audio signals created by another client participating in the face-to-face interaction using the directional microphone.

28. The method of claim 22 wherein said detecting audio signals using said directional microphone comprises detecting audio signals using a microphone array.
